(19) United States
(12) Patent Application Publication
(10) Pub. No.: US 2023/0081813 A1
(43) Pub. Date: Mar. 16, 2023

(54) DEVICE FOR CONTROLLING OUTSIDE OPENING OF A MOTOR VEHICLE DOOR

(71) Applicant: AKWEL VIGO SPAIN SL, Vigo Pontevedra (ES)

(72) Inventors: Delmiro Javier COUTO MAQUIEIRA, Pontevedra (ES); José Oscar VAZQUEZ CARBALLO, Vigo (ES); Oscar PAMPIN AGRA, Vigo Pontevedra (ES); Julio GARCIA RODRIGUEZ, Pontevedra (ES)

(73) Assignee: AKWEL VIGO SPAIN SL, Vigo Pontevedra (ES)

(21) Appl. No.: 17/946,702

(22) Filed: Sep. 16, 2022

(30) Foreign Application Priority Data
Sep. 16, 2021 (FR) 2109722

(51) Int. Cl. E05B 81/90; E05B 81/04; E05B 79/20; E05B 85/16; E05B 79/06

(52) U.S. Cl. CPC E05B 81/90; E05B 81/04; E05B 79/20; E05B 85/16; E05B 79/06

(57) ABSTRACT

A device includes a support, a handle mounted pivotably with respect to the support, a lever for actuating a lock of the door configured to cooperate with an extension element of the handle extending transversely from an inner face of the handle. Moreover, the lever is mounted movable on an axis of articulation of the support against a resilient return member between a first rest configuration of the member in which it extends across a path of the extension element to generate a stress resisting the pivoting of the handle and a second configuration of actuation of the lock in which it is driven in rotation about said axis by the extension element during the pivoting of the handle after having overcome the resisting stress.

### TECHNICAL FIELD

The present invention relates to a device for controlling outside opening of a motor vehicle door. The invention relates more particularly but not exclusively to such a control device which combines an electric actuator and a mechanical actuator, suitable for triggering the opening of a lock of the door of the motor vehicle.

Generally, the control device comprises a maneuvering paddle (or gripping handle) that is mounted articulated with respect to a body panel of the door, inside a case. This case is generally received inside a cutout provided for this purpose in the body panel.

One current trend involves allowing the opening of the door via an electric actuator, itself triggered manually for example by a slight press, a simple light touch or a detection of a close presence of a user in a predefined zone of the control device, generally a non-visible inner face of the maneuvering paddle. During this manual actuation, an electric unlocking command with a view to opening the door of the vehicle is generated for the main control unit of the vehicle.

For security reasons, it is generally provided for the control device of the door to also allow mechanical opening in case of an electric failure. The opening of the mechanical actuator is for example carried out by applying onto the maneuvering paddle a substantially greater actuation force, thus causing the mechanical release of the door by the actuation of a transmission assembly for example a lever connected to the lock.

### PRIOR ART

Such a control device is in particular known from the prior art, and in particular from the publication of the international application WO2021/009294A1.

Such a design of a device for controlling opening allows a particularly intuitive operation of the latter since the motorist who desires to open the door of the vehicle carries out in the same pulling movement first of all an attempt at electric unlocking of the lock mechanism associated with the paddle by manually triggering the electric actuator located in an inner gripping zone of the paddle, then, only in case of failure of the opening of the door, by exerting a pulling force having a greater intensity on the handle. They thus cause without changing movement the opening of the door by exerting on the paddle a pulling force oriented upwards which leads to the pivoting of the paddle and to the mechanical actuation of the lock.

This control device of the prior art has, however, numerous disadvantages.

First of all, this device has the disadvantage of having a relatively complex structure with in particular a large number of parts to be assembled to each other. Moreover, the gripping of the paddle is also not very optimized from an ergonomic point of view since it requires an amplitude of torsion of the wrist of the user when the latter uses the mechanical actuation of the lock of the door.

Faced with these disadvantages, the present invention aims to further improve the devices for controlling outside opening of the type considered. The goal of the invention is in particular to propose a device for controlling outside opening that is more ergonomic, easier to assemble while offering new prospects in the style of the vehicle.

The present invention aims to overcome these disadvantages. A main goal of the invention is to provide a mechanism, the actuation of which remains simple and natural for the user. Yet another goal of the invention is to provide a mechanism for opening a door having a structure that remains relatively simple, with reliable operation.

### SUMMARY OF THE INVENTION

For this purpose, the object of the invention is a device for controlling outside opening of a motor vehicle door, comprising a support, a gripping handle mounted pivotably with respect to the support and extending flush with the panel of the door and having an outer surface that defines a continuity of shape and/or of appearance with a surface of the panel of the door, a lever for actuating a lock of the door, wherein the support is formed by a case body defining a cavity for receiving the gripping handle wherein the handle is arranged to partly close the cavity so that at least an upper or lower longitudinal edge of the handle defines a concave recess in the cavity so as to make an inner face of the handle accessible for gripping in the retracted position of the handle, characterized in that the lever is configured to cooperate with an extension element of the handle extending transversely with respect to a longitudinal direction of the handle from an inner face of the handle and in that the lever is movably mounted on an axis of articulation of the support against a resilient return member between a first rest configuration of the member in which it extends across a path of the extension element to generate a stress resisting the pivoting of the handle and a second configuration of actuation of the lock in which it is driven in rotation about said axis by the extension element during the pivoting of the handle after having overcome the resisting stress.

The present invention thus allows to efficiently and simply oppose the mechanical opening of the handle during its electric actuation on an inner face of the handle. The actuation lever, designated differently below as return lever, is thus particularly practical and not very bulky since it has a dual function. For example, the lever can comprise an end fastened to the end of a cable, the traction of which causes the actuation of the lock of the door.

This therefore prevents the untimely opening of the handle when the device for controlling opening is only used electrically.

For example, the handle extends transversely towards the inside of the door of the vehicle by a branch, forming the extension element or plunger, made in one piece with it or rigidly added on. The inner branch thus pivots about the pivoting axis of the handle with the rest of the handle and describes an opening path towards the outside. It is thus understood from the invention that the lever acts like a stop part that is interposed on the path of the extension element of the handle during the deployment of the latter.

In a preferred embodiment of the invention, the lever can be moved against the member in a third temporary assembly configuration, in which it is temporarily moved away from said path to allow the mounting of the extension element according to said path.

In a preferred embodiment of the invention, the lever can be moved in translation with respect to the support according to the axis of articulation from the first configuration to the third configuration.

In a preferred embodiment of the invention, the lever and the support have contact surfaces cooperating one against the other to form a notch for resistance to the pivoting of the handle with crossing of a hard point.

In a preferred embodiment of the invention, the extension element is provided to be mounted through an opening of the support and the lever extends on a dorsal face of the support opposite to a front face for receiving the handle.

In a preferred embodiment of the invention, the lever comprises a body provided with a cylindrical bore mounted to slide and to pivot around a rod for articulation of the lever fastened onto the support according to the axis of articulation.

In a preferred embodiment of the invention, the lever comprises a body provided with a wing protruding radially with respect to the axis of articulation and configured to extend across said path.

In a preferred embodiment of the invention, the member comprises a helical spring suitable for operating in compression and in torsion according to the axis of articulation.

In a preferred embodiment of the invention, the lever comprises a cylindrical sleeve defining a cylindrical bore according to the axis of articulation and the member comprises a helical winding surrounding the cylindrical sleeve and fastened at one of its free ends to the support and at the other of its free ends to the lever.

In a preferred embodiment of the invention, the lever comprises two arms disposed in an adjacent manner along the axis of articulation and spaced angularly apart from one another, one of the arms forms a wing for radial contact with the extension element and the other of the arms is provided with an end for retaining a traction cable of the lock.

In a preferred embodiment of the invention, the axis of articulation of the lever extends substantially parallel to and at a distance from the longitudinal axis of the handle.

In a preferred embodiment of the invention, the handle comprises a body having an elongated overall shape according to a longitudinal direction having an end part for articulation onto the support about an axis of articulation substantially parallel to the plane of the panel of the door and substantially perpendicular to the longitudinal direction of the handle.

In a preferred embodiment of the invention, the device comprises an element for manual control disposed on the inner face of the handle by means of which an electric command for the electric actuation of the lock can be generated so that a user can carry out in a single movement of gripping of the handle the electric actuation of the lock and, in case of a failure, the mechanical actuation of the lock by applying a stress for pulling the handle towards its opening position.

In a preferred embodiment of the invention, the support comprising a hollow for receiving the handle, the device comprises a shell shaped to line the hollow, the handle and the shell being configured to cooperate together so that the shell cannot be extracted from the support after assembly of the handle onto the support.

In a preferred embodiment of the invention, the support comprises a cavity configured to impose onto the shell an intermediate mounting and/or disassembly position passing through a final location of the handle in the cavity of the support.

In a preferred embodiment of the invention, the support comprises a location for transversely receiving a fake cylinder part provided with a front presentation face, the handle being configured in the support to cover the presentation face in the rest position.

In a preferred embodiment of the invention, the support comprises a path of passage that extends from the outside to the lever into which a tool for mounting the handle can be inserted to temporarily move the lever against the member in order to allow the release of the movement of the handle towards a mounting position.

In a preferred embodiment of the invention, the handle extends flush with the panel of the door and has an outer surface that defines a continuity of shape and/or of appearance with a surface of the panel of the door.

### BRIEF DESCRIPTION OF THE DRAWINGS

Other features and advantages of the invention will appear in the light of the following description, made in reference to the appended drawings in which:

FIG. 1 shows a perspective view of an outer face of a vehicle door panel integrating in the façade a device for controlling outside opening according to the invention;

FIG. 2 shows a perspective view of an inner face of the panel of FIG. 1;

FIG. 3 shows a perspective view of the panel of FIG. 1 in a non-assembled configuration;

FIG. 4 shows a perspective view of a rear face of the device of FIG. 1 in an operational configuration;

FIG. 5 shows an exploded perspective view of the device of FIG. 4;

FIG. 6 shows a perspective view of a rear face of the device of FIG. 1 in a temporary assembly configuration;

FIGS. 7A, 7B, and 7C show in perspective an actuation lever of the device of the invention for actuating a lock of the door according to three points of view 7A, 7B, and 7C spaced apart angularly;

FIG. 8 shows a perspective view with a partial cutaway of the control device of FIG. 1 in which a manual switch element for electric actuation of a lock of the door is visible;

FIG. 9 shows a view of a lateral edge of the door and a box illustrating in detail the control device;

FIG. 10 shows a partial view of a longitudinal cross-section of the handle support of the device of FIG. 1, of the lever and of the handle;

FIG. 11 shows a front view of the device for controlling opening in the assembled state on a “driver's side” door of the vehicle;

FIGS. 12A and 12B show the device of FIG. 1 during mounting of a liner shell according to two different assembly modes (12A or 12B);

FIGS. 13A and 13B show a partial view of a longitudinal cross-section of the device for controlling opening in a rest configuration (13A) and in an active configuration (13B);

FIGS. 14A and 14B show a partial view of a transverse cross-section of the device for controlling opening in a rest configuration (14A) and in an active configuration (14B).

### DESCRIPTION OF THE EMBODIMENTS

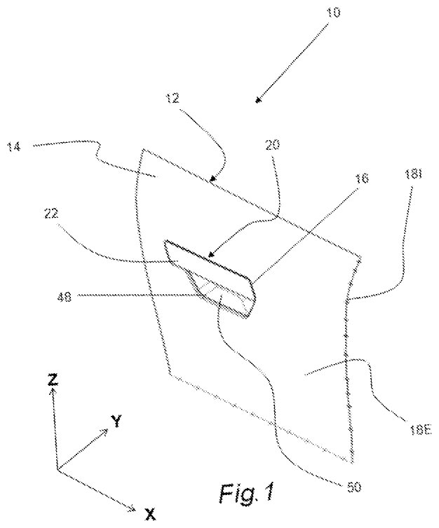

FIGS. 1 to 14B show a device for controlling outside opening of a motor vehicle door according to the invention. In the rest of the description, the device will be designated by the general reference 20, the door by the general reference 12 and the motor vehicle by the general reference 10.

An orthonormal reference frame is indicated in FIG. 1. It defines a first direction which corresponds to a longitudinal axis X of the vehicle, oriented positively from the front to the rear of the vehicle, a second direction which corresponds to a transverse axis Y of the vehicle and a third direction which corresponds to a vertical axis Z of the vehicle.

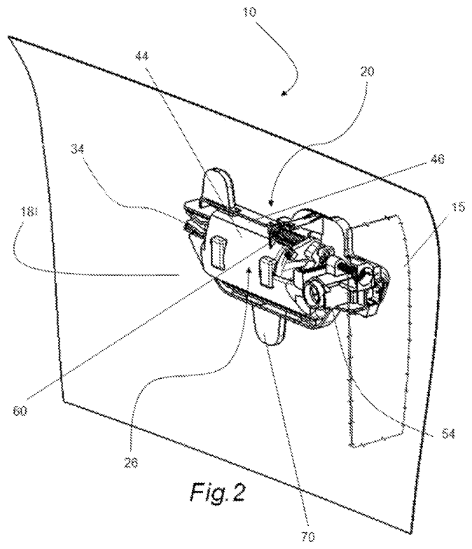

In FIGS. 1 and 2, the control device 20 is intended to be mounted on an outer body panel 14 of the door 12 which is for example a side door of the motor vehicle 10. The panel 14 comprises a visible outer face 18E and a hidden inner face 181.

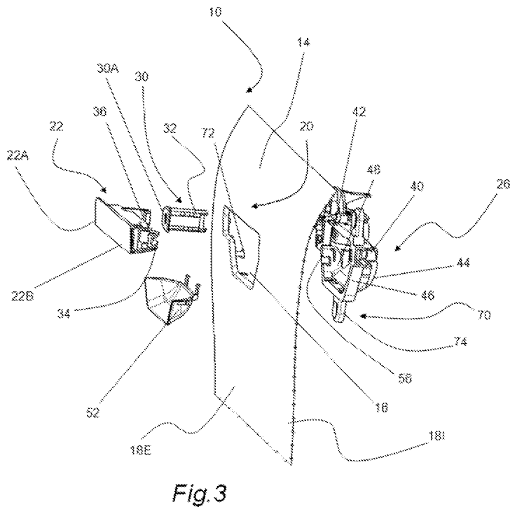

In general, as visible in FIG. 3, the device 20 comprises a handle support 26 intended to be mounted in a cutout 16 having a complementary shape formed in the outer panel 14 of the door 12 and a gripping handle 22 pivotably mounted on the support 26.

Conventionally, the motor vehicle 10 also comprises a door lock (not shown) typically mounted on the door 12 of the vehicle 10 and configured to be mechanically and/or electrically actuated.

In this example, the handle 22 is intended for the maneuvering of the door 14 as well as for the mechanical actuation of opening of the lock of the motor vehicle 10. Preferably, the lock is connected to the gripping handle 22 by a mechanical link (also designated as transmission assembly) which will be explained in detail below and which allows the mechanical actuation of the opening.

Generally, the opening of a door of a motor vehicle is carried out for example by means of a lock comprising a bolt (not shown) rigidly connected to the door capable of cooperating with a strike (not shown) rigidly connected to the body of the vehicle. In practice, the action of releasing the bolt, which allows the unhooking of the door, is called opening of the lock. Inversely, maintaining the bolt in the strike, which prevents the unhooking of the door, is called closing of the lock.

For example, the function of the lock is to maintain in a closed position the door 12 of the motor vehicle 10. The lock also allows to unhook the door 12 by action on the device for controlling outside opening 20 which is connected to the lock and can be actuated by a user. The bolt is removed from the strike by electric or mechanical actuation of the outside opening 20 control.

The opening of the lock can be carried out electrically via an electromechanical actuator (not shown in the drawings). In this case, the actuator (not shown) comprises for example an electric motor, electrically powered by the main electric circuit of the vehicle. This electric motor is dimensioned to allow the opening of the lock and of the door under normal operating conditions.

The lock is also preferably connected to an electronic central processing unit (not shown in the drawings) for controlling the locking and the unlocking of the various locks with which the motor vehicle 10 is equipped.

In the preferred embodiment of the invention, the device 20 also comprises a cylinder part 30 frontally having a presentation face 30A. The cylinder part 30 has in the example illustrated in FIG. 3 a cylindrical overall shape with a preferably relatively flat front presentation face 30A.

In case of electric failure, preferably the lock can be mechanically unlocked. For this purpose, in a “driver” door configuration of the vehicle 10, conventionally, the cylinder part 30 of the device 20 is functional and is configured to allow the insertion of a lock key by its presentation face 30A. As illustrated in FIG. 11, in this case, the device 20 comprises a lock cover 32 in the shape of a hood provided to be removably mounted (articulated in rotation or not) above the location of the cylinder part 30 and can be removed manually in order to free the access to the presentation face 30A to allow the insertion of the lock key.

When the control device 20 is provided to be mounted in a “passenger” door configuration, as illustrated in particular in FIGS. 1 and 3, the cylinder part 30 is preferably a fake part and is inoperative. Preferably, in this case, the handle 22 is extended according to the longitudinal direction to cover and to mask the cylinder part 30 in the rest position of the handle 22.

Preferably, as illustrated in FIG. 3, the support 26 is formed by a case body 40 which is intended to be fastened on the inner side 181 of the panel 14 and the gripping handle 22 is intended to be arranged on the outer side 18E of the panel 14, while being added onto the case body 40 forming a support.

In this exemplary embodiment, the gripping handle 22 is in the form of a body having an elongated overall shape that extends according to the longitudinal direction X. The side of the handle 22 that includes the axis of articulation will be called rear side 22B and the opposite side will be called front side 22A. This orientation from rear to front substantially corresponds to an orientation from the right to the left in FIG. 1.

According to the invention, as visible in FIG. 3, the handle 22 is mounted articulated on the support 26 by the end rear side 22B about an axis of articulation extending according to the vertical direction Z with respect to the case body 40 and for example across an opening 23 made in the peripheral wall 46 of the case 40. The axis of articulation will be called vertical, that is to say substantially parallel to the plane of the outer panel 14 and perpendicular to the longitudinal direction X of the gripping handle 22.

The gripping handle 22 is mounted articulated about the geometric axis of articulation with respect to the support 26 between at least a rest retracted extreme position and an opening deployed extreme position causing the mechanical actuation of the opening of the lock of the door 12 causing the unhooking of the door 12, as will be explained in detail below.

In order to allow the articulation of the handle 22, in the example illustrated, its rear side 22B includes an end 34 provided to be mounted with rotation about a pivot axis rigidly connected to the support 26 (not visible in the drawings).

Moreover, in the example illustrated, on the front side 22A, the handle 22 is mechanically coupled to the mechanism of the lock. This allows via the maneuvering of the handle 22 the mechanical actuation of the opening of the lock and the unhooking of the door 12.

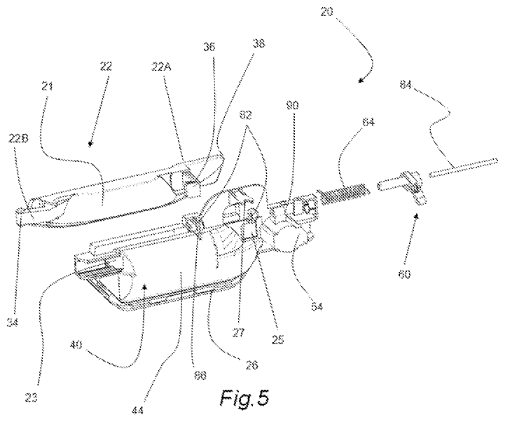

For this purpose, preferably, as visible in FIG. 5, the handle 22 comprises, on its front side 22A, an extension element 36 extending transversely from an inner face of the handle 22 and configured to act on a mechanical transmission assembly coupled to the mechanism of the lock that allows to carry out the mechanical opening of the lock of the door 12. The extension element 36 has in the example illustrated the shape of a branch or of a column which has a free end 38 curved in the manner of a foot. This extension element 36, well known from the prior art, is also sometimes designated by the term “plunger”.

As is clear in FIG. 3, the case body 40 frontally has an open front face 42 on the outside of the door 12 in the overall shape of a frame and a rear wall 44 that is arranged to extend on the inner side of the panel 14 of the door 12. The case body 40 also comprises in this example a peripheral wall 46 which defines with the rear wall 44 a cavity 48 for receiving the handle 22, open towards the outside of the door 12.

In order to allow the mechanical actuation of the lock by the extension element 36, preferably and as illustrated in FIG. 5, the case body 40 comprises an opening 25 made in the rear wall 44, through which the extension element 36 can be inserted in such a way that the foot 38 can cooperate with the transmission assembly located on the inner side of the rear wall 44.

Preferably, as visible in FIG. 1, the cavity 48 of the case body 40 is arranged in the panel 14 of the door 12 to extend set back with respect to the outer surface of the panel 14 and thus receive the gripping handle 22 in a manner substantially flush with the outer surface of the panel 14 (or body skin of the vehicle). Preferably, the handle 22 has an outer surface that defines a surface continuity with a surface of the panel 14 of the door 12 and optionally also a continuity of appearance.

As illustrated in FIG. 1, the handle 22 is arranged in the body of the case 40 to partly close the inner cavity 48 of the case body 40 in the rest position so that in the example illustrated, a lower longitudinal edge of the handle 22 defines vertically towards the bottom a concave recess 50 in the shape for example of a bucket or a half-bowl allowing the introduction of the hand of a user behind the handle 22. In this illustrated example and optionally, the handle 22 has on its dorsal face a bulge that is configured to substantially conform to the concave recess 50 and which defines a cavity to allow the introduction of the hand.

In the retracted position of the handle 22, the cavity 48 open towards the outside is partly closed by the handle 22 so as to make accessible for gripping a lower face of the handle 22 by the recess 50. Indeed, when the hand of the user slides into the recess 50 of the case body 40, the inner face of the phalanges of the user is facing the inner face of the handle 22.

Of course, alternatively, the handle 22 can be arranged so as to close a lower portion of the inner cavity 48 so that an upper longitudinal edge of the handle 22 vertically defines in this case upwards the concave recess. It is also possible for the handle 22 to be able to be arranged so as to close a median portion of the inner cavity 48 so that the handle 22 vertically defines both upwards and downwards concave recesses.

Preferably, in the preferred embodiment of the invention illustrated in FIG. 3, the device 20 also comprises a lining shell 52 configured to conform to the recess 50 of the open cavity 48 of the case 40 not closed by the handle 22 in its rest position. The shell 52 forms in this example a finishing trim allowing to line the part of the hollow 48 of the case body 40 not covered by the handle 22 in its rest position.

For example, as visible in FIGS. 1 and 3, the case 40 is functionally composed of at least two parts: a first upper part for receiving the handle 22 in the rest position and a second lower part for access to the gripping handle 22 in its rest position. This second part comprises the concave hollow 48 open towards the outside that forms the recess 50 for access to the inner face of the handle 22 in its rest retracted position.

In the example illustrated, the case body 40 comprises in the longitudinal direction at one end of its first part a location in which a bore 54 shaped to transversely house the cylinder part 30 so that the cylinder 30 frontally presents its presentation face 30A is made.

Moreover, preferably, in the “passenger” door configuration, the front end part 22A of the handle 22 is shaped to mask the presentation face 30A in the rest position of the handle 22. In the preferred configuration of the invention, the front end part 22A of the handle 22 forms an extension of the handle 22 beyond a position of the actuation branch 36 of the handle 22.

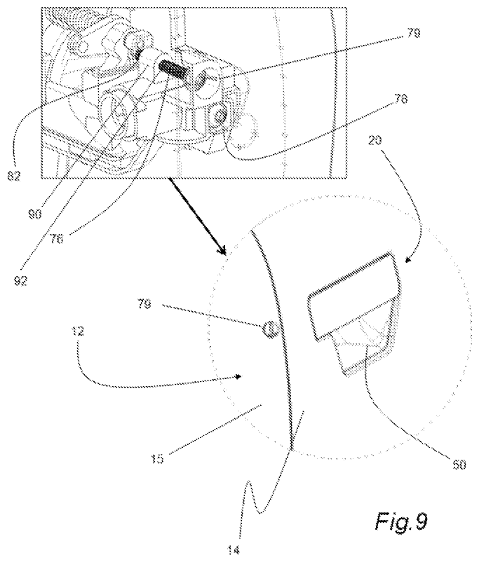

In the preferred embodiment of the invention, the visual definition of the first and second parts of the case body 40 is marked by a vertical step 56 forming a shoulder and visible for example in FIG. 3. In the example illustrated, the case body 40 has a contour having an oblong overall shape and is provided with a protrusion in the shape of a lobe in which the location for the cylindrical bore 54 for receiving the cylinder part 30 is located. In the example illustrated in FIG. 9, the cylinder part 30 comprises a means 78 for fastening to a lateral wall 46 of the support 26.

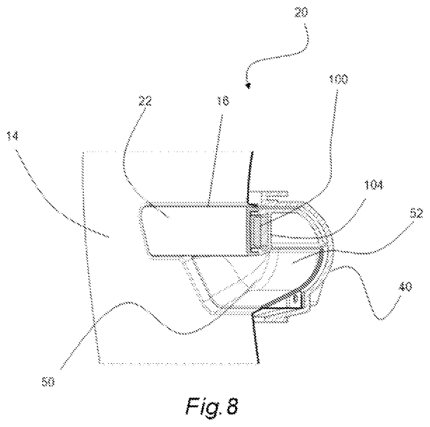

Preferably, as shown in FIG. 8, the device 10 also comprises a manual control element 100 disposed on an inner face for gripping the handle 22 by means of which an electric command for the electric opening of the lock of the door 12 can be generated.

The manual control element 100 can for example comprise, as an example but not in a limiting way, a gesture and/or touch detector configured to detect at least one control instruction related to a result of the gesture and/or touch detection in a control region preferably located on the inner face of the handle 22.

The detector comprises for example a sensor using a technology of resistors sensitive to pressure (also known by the name FSR sensor for Force Sensing Resistor), using for example resistive inks sensitive to pressure, an optical technology or a capacitive technology. Such technologies are well known to a person skilled in the art and will not be described in greater detail below.

Via this manual control actuatable by a simple touch, a very slight pressure or a detection of the presence of the user, the latter can carry out in a single movement of gripping of the handle 22 the electric unlocking of the lock of the door and, only in the case of a failure, the mechanical unlocking of the lock of the door by applying a stress for pulling the handle towards the opening position.

It is thus understood that in a normal use of the device 20, the handle 22 is provided to occupy for the most part its rest retracted position and to only be maneuvered occasionally to its deployed position, in the case in particular of an electric failure.

In general, in order to ensure mechanical operation of the unlocking of the lock of the door 12, the device 20 comprises a lever 60 for actuation of the lock configured to cooperate with the inner branch 36 of the handle 22 with a view to unlocking the lock.

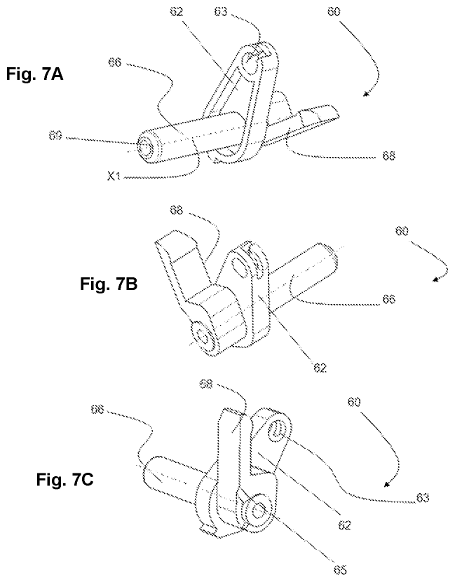

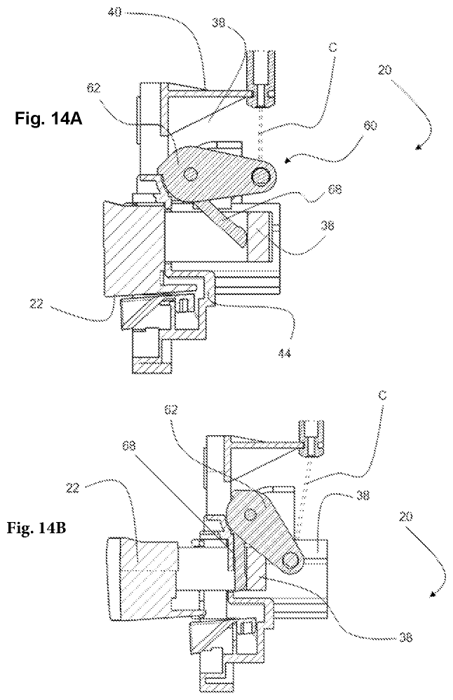

This lever 60 is illustrated in detail in FIGS. 7A-7C. In this example, the lever 60 is part of the mechanical transmission assembly and is configured to pull a cable C of the lock during the movement of the handle 22 towards its deployed position (the cable C is schematically shown by two lines of dotted lines in FIGS. 14A and 14B).

According to the invention, the lever 60 is movably mounted, against a resilient return member 64 on an axis of articulation X1 of the support 26 about which the lever 60 can in particular pivot between at least a first rest (or resilient return) configuration in which it extends across an opening path of said branch 36 and at least a second active configuration of unlocking of the lock in which it is driven in rotation about said axis by said branch 36 of the handle 22.

For this purpose, the lever 60 comprises a body provided with a cable traction arm 62 extending radially from the axis of articulation X1. This arm 62 comprises a means 63 for mechanical connection to an element of the mechanical transmission assembly, such as the cable C. The support 26 preferably also comprises a cable-guide element 27 formed by a protruding stud provided with a notch on an end edge inside which the cable can slide.

In this example, the arm 62 has the overall shape of an elongated tab in the shape of a “drop of water”, that is to say having a rounded base around the axis of articulation X1 and an opposite free end slightly thinned to a point comprising the mechanical linking means 63. Structurally, the mechanical linking means 63 comprises a housing in which an end of the cable C can be inserted and retained. For example, the cable C comprises a sheath provided at its proximal end with a head forming an element for retaining the cable inside the housing. The housing has a curved overall shape and is provided with a circumferential slot defining a guide groove through which the sheath of the cable can be inserted radially and opening onto an axial extension orifice via which the head of the cable can be removably inserted axially.

Moreover, preferably, in order to cooperate with the branch 36 for extension of the handle 22 from its rest configuration to its active configuration, the lever 60 also comprises an arm 68 for blocking the pivoting of the handle 22 extending radially from the axis of articulation X1.

The blocking arm 68 is in the form of a fin or of a pin protruding radially with respect to the axis of articulation X1 and configured to extend across said path. Preferably, the two arms 62 and 68 extend in a manner adjacent to one another according to the axis of articulation X1.

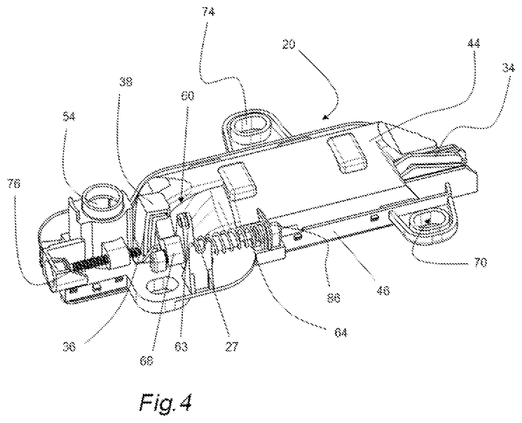

As visible in FIG. 4, in the rest configuration of the lever 60, the traction arm 62 extends substantially in a transverse direction of the support 26 and the blocking arm 68 is inclined with respect to the transverse direction so that the two arms 62 and 68 have an angular spacing according to their radial directions. The foot 38 of the extension branch 36 engages against a bearing face of the fin or of the pin 68 so that the movement of the handle 22 is only possible by overcoming the resisting stress generated by the presence of this fin 68 on the path.

In the example described, during the opening of the handle 22 towards its deployed position, the extension branch 36 comes in contact with the radial fin 68, which has the effect of pivoting the lever 60 in its entirety when the force of traction of the handle 22 overcomes the resisting stress generated by the presence of the fin 68 and thus of causing the traction of the cable allowing to cause the unhooking of the lock.

Moreover, the support 26 comprises a rod 84 for articulation of the lever 60 which extends according to the axis of articulation X1 of the lever 60 in an assembled position and giving a physical form to the axis of articulation X1 of the lever 60 on the support 26. For this purpose, the lever 60 also comprises an axial extension 66 in the form of a cylindrical sleeve that is provided with a cylindrical bore 69 allowing its assembly and its mounting about the articulation rod 84 of the support 26.

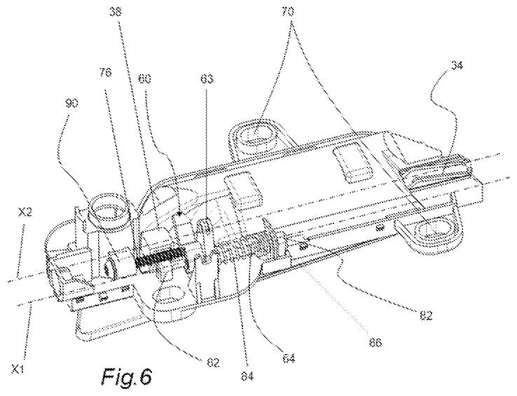

As illustrated in FIG. 6, the rod 84 extends on the support 26 between two bearings 82 in the form of a stud protruding transversely from a dorsal face of the rear wall 44 of the support 26. The lever 60 is mounted movably in rotation about the rod 84 and also as will be explained in detail below can slide along the rod 84 according to a predetermined trajectory.

Preferably, the two traction 62 and blocking 68 arms as well as the cylindrical sleeve 66 are molded in a single part from a plastic material.

Moreover, the spring 64 is configured to be centered and guided mainly around the cylindrical sleeve 66 and to extend between the lever 60 and one of the bearings 82.

In this example, the spring 64 comprises two free ends, one of the free ends being fastened onto the lever 60 and the other of the free ends being fastened to one of the bearings 82. Preferably, this bearing 82 for fastening of the spring 64 further comprises a fastening flange 86 provided with a sleeve journal around which one of the free ends of the spring 64 is wound. For this purpose, the traction arm 62 defines a radial bearing face for one of the ends of the spring 64. The bearing face of the fastening bearing 82 has for example a peripheral frame defining a cavity for receiving and retaining the end of the spring 64 (FIG. 7A).

In order to avoid an untimely opening of the handle 22 during an electric actuation of the device 20, a mechanism for resistance to the opening of the handle 22 from its retracted position to its deployed position is provided. The mechanism comprises for example a crossing of a hard point that opposes an untimely mechanical opening of the handle 22.

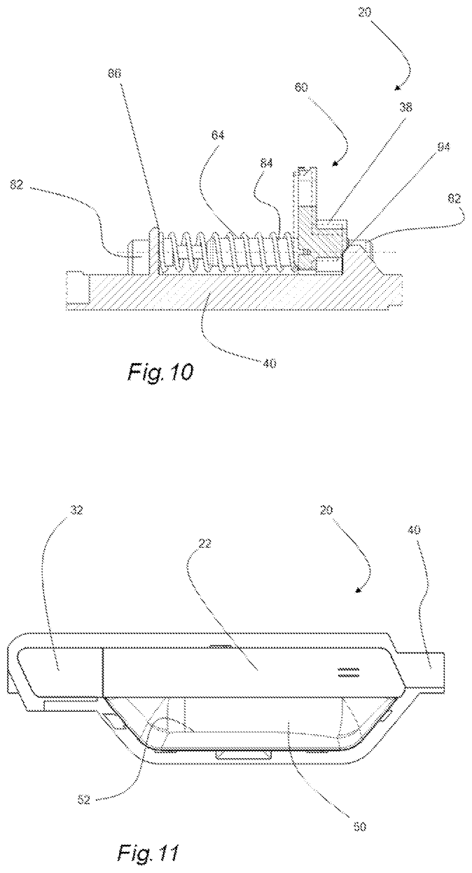

Preferably, as shown in FIG. 10, in order to generate a significant resisting stress to the opening of the handle 22, the lever 60 and the support 26 have surfaces in contact cooperating one against the other to form a notch 94 for resisting the pivoting of the lever 60 and thus of the handle 22 with crossing of a hard point. These surfaces in contact can have reliefs or predetermined shapes which can generate a resisting stress sufficient to prevent an accidental opening of the handle 22 but which can be overcome manually by a traction stress of increased intensity.

Preferably, in the preferred embodiment of the invention, the lever 60 can be moved against the resilient return member 64 in a third temporary assembly configuration, in which it is temporarily moved away from said path to allow the mounting of the handle 22 of the extension element 36 according to said path thus freed.

In the example described, the lever 60 can thus also be moved in translation with respect to the support 26 according to the axis of articulation X1 from the first configuration to the third configuration, for example by compression of the spring 64. This degree of freedom allows the lever 60 to temporarily remove the blocking pin 68 from the trajectory of the extension element 36 to allow the free insertion of the extension element 36 up to its definitive position.

In this example and preferably, the resilient return member 64 comprises a helical spring capable of operating in compression and in torsion according to the axis of articulation X1.

Preferably, the actuation branch 36 of the handle 22 extends transversely inside the support 26 by passing through the rear wall 44 of the case 40 so that the end 38 of the actuation branch 36 cooperates with the lever 60 mounted at the rear of the case 40 (FIG. 2), in particular on a dorsal face of the rear wall 44.

The extension element 36 is provided to be mounted through a through-hole 25 of the support 26 and the lever 60 extends on a dorsal face of the support 26 opposite to a front face for receiving the handle 22.

As illustrated in FIG. 6, the axis of articulation X1 of the lever 60 extends substantially parallel to and at a distance from the longitudinal axis X2 of the handle 22.

Preferably, as illustrated in FIG. 9, the support 26 comprises a path of passage 90 that extends from the outside to the blocking lever 60 into which a temporary mounting tool that can be for example a screw 76 (FIG. 9) can be inserted. When the tool is inserted into the path of passage 90, for example formed by a through-hole 92 of an element of the support 26 in relief, it can temporarily move the lever 60 against the resilient return member 64 in order to allow the installation of the handle 22 in its final assembly destination position inside the case 40.

For example, advantageously, when the mounting tool is a mounting screw 76 as illustrated in FIG. 6, the device 20 can be delivered pre-assembled with the mounting screw 76 in the screwed state that is to say engaging with the lever 60 in the temporary configuration of the handle 22 easily allowing the installation of the handle 22 in its mounting position. Once the handle 22 is installed on the support 26, the mounting screw 76 can be unscrewed in order to release the lever 60 and allow its resilient return into the rest configuration in which the lever 60 blocks the opening of the handle 22 by its blocking pin 68.

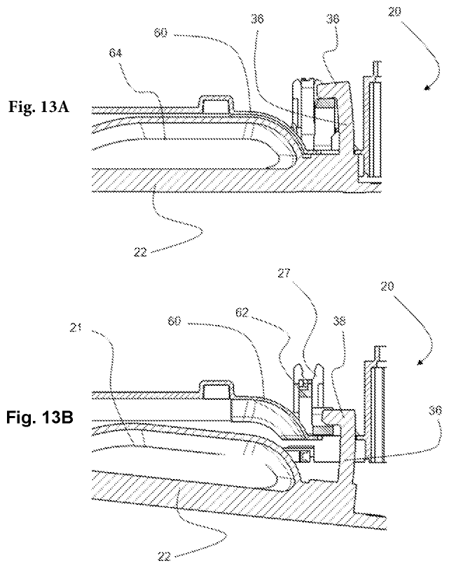

In reference to the drawings the main aspects of operation of the mechanism for resistance to the opening 60 will now be described in reference to FIGS. 13A, 13B, 14A, and 14B. In the rest position (FIG. 13A and FIG. 14A), the lever 60 is maintained by the deployed spring 64, in a blocking configuration resisting the opening of the handle 22 in an untimely manner.

In the case of a significant traction stress exerted on the handle 22, the application of the curved pin 38 onto the lever 60 causes the torsion of the return member 64 and the pivoting of the blocking arm 68 of the lever 60, which allows the unlocking of the lock by simultaneous pivoting of the traction arm 62 (FIG. 13B and FIG. 14B). In the preferred embodiment of the invention, the user must exert a handle traction stress allowing to overcome not only the return force of the spring 64 but also the notch 94 with crossing of a hard point.

The device 20 according to the invention also differs from the prior art by a simplicity of design allowing a simple and robust assembly without requiring the use of multiple parts.

Indeed, in the example illustrated in FIG. 3, the case body 40 forming the support 26 is added onto the panel 14 of the door 12 by rapid coupling means 70. As visible in the drawings, the door 12 panel 14 has at the periphery of its cutout 16 a plurality of protrusions 72 for snapping on or fitting together and the case body 40 comprises a plurality of complementary cavities 74 made at the peripheral edge of the front face of the case 40.

The protrusions 72 and the complementary cavities 74 form in this example the rapid coupling means 70. However, other rapid coupling means are possible without going beyond the context of the invention. These rapid coupling means of the two parts (the case body 40 and the panel 14) advantageously allow to relatively position the two parts with respect to each other before fastening them to one another by conventional fastening means. This allows easy, rapid and precise positioning of the support 26 during its mounting on the door panel 14.

In the example illustrated in FIG. 8, it can be seen that the case body 40 is secured to the panel 14 by conventional fastening means such as screws and fastening holes.

Moreover, preferably, the door 12 laterally has an orifice 79 configured to allow the access to the fastening of the screws 76 and 78 (FIG. 9). This orifice 79 is for example made accessible by a lateral wall 15 of the door 12 during the opening of the door 12.

The trim shell 52 and the support 26 are preferably shaped to fit one in the other as illustrated in figure door 12. The shell 52 is shaped to line the hollow 50, the handle 22 and the shell 52 being configured to cooperate together so that the shell 52 cannot be extracted from the support 26 after assembly or installation of the handle 22 on the support 26 in its final destination mounting position.

Preferably, the cavity 48 of the support 26 is configured to impose on the shell 52 an intermediate mounting and/or disassembly position crossing a final location of the handle 22 in the cavity 48 of the support 26. In the example illustrated, the shell 52 reaches an intermediate mounting position crossing the first part of the case body 40 intended to receive the handle 22. Consequently, once the handle 22 is positioned in the cavity 48, the shell 52 cannot be removed without crossing the location for receiving the handle 22 which is thus made uncrossable by the handle 22.

Preferably, the cavity 48 and the shell 52 are shaped to prevent the putting in place of the shell 52 according to a transverse direction of fitting together inside the cavity 48 directly in a final destination position of the shell 52.

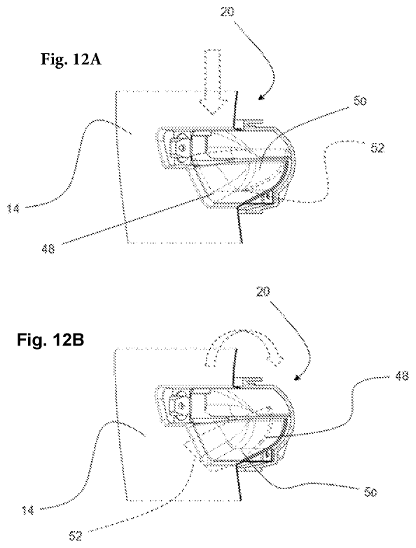

For example, in reference to FIGS. 12A and 12B, the intermediate mounting position (shown in dotted lines) is a vertically higher position with respect to the final destination position of the shell 52 in the support 26 (mode A) or an inclined position with respect to the final destination position of the shell 52 (mode B) or a combination of these two intermediate positions.

Such a device for controlling outside opening 20 reduces the number of parts to be supplied, manipulated and mounted.

Of course, the invention is not limited to the embodiments described above. Other embodiments within the reach of a person skilled in the art are also possible without going beyond the context of the invention defined by the claims below.

1. A device for controlling outside opening of a motor vehicle door, comprising a support, a gripping handle mounted pivotably with respect to the support and extending flush with the panel of the door and having an outer surface that defines a continuity of shape and/or of appearance with a surface of the panel of the door, a lever for actuating a lock of the door door, wherein the support is formed by a case body defining a cavity for receiving the gripping handle wherein the handle is arranged to partly close the cavity so that at least an upper or lower longitudinal edge of the handle defines a concave recess in the cavity so as to make an inner face of the handle accessible for gripping in the retracted position of the handle, wherein the lever is configured to cooperate with an extension element of the handle extending transversely with respect to a longitudinal direction of the handle from an inner face of the handle and in that the lever is mounted movable on an axis of articulation of the support against a resilient return member between a first rest configuration of the member in which it extends across a path of the extension element to generate a stress resisting the pivoting of the handle and a second configuration of actuation of the lock in which it is driven in rotation about said axis by the extension element during the pivoting of the handle after having overcome the resisting stress.

2. The device according to claim 1, wherein the lever can be moved against the member in a third temporary assembly configuration, in which it is temporarily moved away from said path to allow the mounting of the extension element according to said path.

3. The device according to claim 2, wherein the lever can be moved in translation with respect to the support according to the axis of articulation from the first configuration to the third configuration.

4. The device according to claim 1, wherein the lever and the support have contact surfaces cooperating one against the other to form a notch for resistance to the pivoting of the handle with crossing of a hard point.

5. The device according to claim 1, wherein the extension element is provided to be mounted through an opening of the support and the lever extends on a dorsal face of the support opposite to a front face for receiving the handle.

6. The device according to claim 1, wherein the lever comprises a body provided with a cylindrical bore mounted to slide and to pivot around a rod for articulation of the lever fastened onto the support according to the axis of articulation.

7. The device according to claim 1, wherein the lever comprises a body provided with a wing protruding radially with respect to the axis of articulation and configured to extend across said path.

8. The device according to claim 1, wherein the member comprises a helical spring suitable for operating in compression and in torsion according to the axis of articulation.

9. The device according claim 8, wherein the lever comprises a cylindrical sleeve defining a cylindrical bore according to the axis of articulation and the member comprises a helical winding surrounding the cylindrical sleeve and fastened at one of its free ends to the support and at the other of its free ends to the lever.

10. The device according to claim 1, wherein the lever comprises two arms disposed in an adjacent manner along the axis of articulation and spaced angularly apart from one another, one of the arms forms a wing for radial contact with the extension element and the other of the arms is provided with an end for retaining a traction cable of the lock.

11. The device according to claim 1, wherein the axis of articulation of the lever extends substantially parallel to and at a distance from the longitudinal axis of the handle.

12. The device according to claim 1, wherein the handle comprises a body having an elongated overall shape according to a longitudinal direction having an end part for articulation to the support about an axis of articulation substantially parallel to the plane of the panel of the door and substantially perpendicular to the longitudinal direction of the handle.

13. The device according to claim 1, comprising a manual control element disposed on the inner face of the handle by means of which an electric command for the electric actuation of the lock can be generated so that a user can carry out in a single movement of gripping of the handle the electric actuation of the lock and, in case of a failure, the mechanical actuation of the lock by applying a stress for pulling the handle towards the opening position.

14. The device according to claim 1, wherein the support comprising a hollow for receiving the handle, the device comprises a shell shaped to line the hollow, the handle and the shell being configured to cooperate together so that the shell cannot be extracted from the support after assembly of the handle onto the support.

15. The device according to the preceding claim 14, wherein the support comprises a cavity configured to impose onto the shell an intermediate mounting and/or disassembly position crossing a final location of the handle in the cavity of the support.

16. The device according to claim 1, wherein the support comprises a location for transversely receiving a fake cylinder part provided with a front presentation face, the handle being configured in the support to cover the presentation face in the rest position.

17. The device according to claim 1, wherein the support comprises a path of passage that extends from the outside to the lever into which a tool for mounting the handle can be inserted to temporarily move the lever against the member in order to allow the release of the movement of the handle towards a mounting position.
